(19) United States
(12) Patent Application Publication
(10) Pub. No.: US 2010/0228863 A1
(43) Pub. Date: Sep. 9, 2010

(54) CONTENT DISTRIBUTION SYSTEM AND ITS CONTROL METHOD

(75) Inventor: Hiroto Kawauchi, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/593,222

(22) PCT Filed: Mar. 28, 2007
(86) PCT No.: PCT/JP2007/056707

§ 371 Date: Apr. 1, 2010

(51) Int. Cl. G06F 15/16

(52) U.S. Cl. 709/227

(57) ABSTRACT

A content distribution system in which, when it is detected that an incommunicable area is present in a moving direction of a client terminal, the client terminal transmits a change request signal, requesting an increase of the confirmation interval of a keep-alive signal, to the content distribution server before the client terminal enters the incommunicable area. When the change request signal is received during distribution of content data, the content distribution server increases the confirmation interval of the keep-alive signal, thereby allowing the session of content distribution to be maintained while the client terminal is in motion within the incommunicable area.

### TECHNICAL FIELD

The present invention relates to a content distribution system in which content data is distributed from a content distribution server to a client terminal.

### BACKGROUND ART

The Real Time Streaming Protocol (RTSP) is a communication protocol used to control distribution of content data such as moving image data that is distributed through streaming from a moving image distribution server to a client terminal via a wired or wireless network. In this communication protocol, the client terminal needs to transmit a keep-alive signal to the server for each confirmation time interval (for example, 60 seconds) in order to confirm that a communication connection has been normally established between the client terminal and the server. When the server cannot receive a keep-alive signal within a confirmation time interval, the server assumes that it is not possible to establish a communication connection with the client terminal for some reason and terminates an ongoing session which is one continuous content data distribution operation.

A movable client terminal such as an in-vehicle terminal often enters an incommunicable area such as a tunnel after establishing a communication connection. If the client terminal moves within such an incommunicable area for more than a specified interval, the session may be unilaterally terminated. In one conventional system (see Japanese Patent Application Publication No. 2006-173973), the client terminal requests that the server stops transmission of content data or changes the transfer rate or coding rate (or compression ratio) before the client terminal enters an incommunicable area in order to prevent unstable reproduction of content data on the client terminal due to the termination of the session. In this conventional system, the presence of an incommunicable area is predicted in advance and the transfer rate is controlled to increase the amount of data distributed from the server before the client terminal enters the incommunicable area. The client terminal uses map data and position information and monitors the status of its buffer memory to transmit a control instruction of the transfer rate to the server, thereby achieving smooth reproduction of content data.

In this conventional system, even when the session is terminated in the incommunicable area, content data continues to be reproduced as long as the content data is stored in the buffering unit. However, the conventional system has problems in that the client terminal must instruct the sever to reestablish a session including a communication connection therebetween when the client terminal has returned to a communicable area from the incommunicable area and that it takes a long time to resume distribution of content data.

### DISCLOSURE OF THE INVENTION

Therefore, the present invention has been made, for example, in view of the above problems, and it is an object of the present invention to provide a content distribution system and a method for controlling the same which can prevent termination of a session even when a client terminal moves in an incommunicable area.

In accordance with one aspect of the present invention, a content distribution system includes a content distribution server which performs distribution of content data and a movable client terminal which receives content data distributed from the content distribution server after establishing a communication connection with the content distribution server, the client terminal including a transmission unit which repeatedly transmits a keep-alive signal, indicating that the communication connection is effective during distribution of the content data, to the content distribution server, a detection unit which detects presence of an incommunicable area in a moving direction of the client terminal, and a transmission unit which transmits a change request signal, requesting an increase of a confirmation interval of the keep-alive signal, to the content distribution server before the client terminal enters the incommunicable area, the content distribution server including a reception unit which receives the keep-alive signal and the change request signal from the client terminal during distribution of the content data, a distribution control unit which terminates a session of distribution of the content data when a next keep-alive signal is not received within the confirmation interval from a time at which a previous keep-alive signal is received, and a setting unit which increases the confirmation interval when the change request signal is received, thereby allowing the session to be maintained while the client terminal is in motion within the incommunicable area.

In accordance with another aspect of the present invention, there is provided a method for controlling a content distribution system including a content distribution server which performs distribution of content data and a movable client terminal which receives content data distributed from the content distribution server after establishing a communication connection with the content distribution server, comprising the steps of: in the movable client terminal, repeatedly transmitting a keep-alive signal, indicating that the communication connection is effective during distribution of the content data, to the content distribution server; detecting presence of an incommunicable area in a moving direction of the client terminal; and transmitting a change request signal, requesting an increase of a confirmation interval of the keep-alive signal, to the content distribution server before the client terminal enters the incommunicable area, and further comprising the steps of: in the content distribution server, receiving a signal transmitted from the client terminal, the signal including the keep-alive signal and the change request signal, during distribution of the content data; terminating a session of distribution of the content data when a next keep-alive signal is not received within the confirmation interval from a time at which a previous keep-alive signal is received; and increasing the confirmation interval when the change request signal is received, thereby allowing the session to be maintained while the client terminal is in motion within the incommunicable area.

### BRIEF DESCRIPTION OF DRAWINGS

FIG. 1 illustrates a configuration of a content distribution system according to the present invention;

FIG. 2 is a block diagram illustrating a schematic configuration of a moving image distribution server in the system of FIG. 1;

FIG. 3 is a block diagram illustrating a schematic configuration of an in-vehicle client terminal in the system of FIG. 1;

FIG. 4 is a flow chart illustrating a keep-alive transmission control operation;

FIG. 5 is a flow chart illustrating a confirmation interval change operation;

FIG. 6 is a flow chart illustrating a keep-alive reception control operation;

FIG. 7 is a flow chart illustrating a moving image distribution control operation;

FIG. 8 illustrates the confirmation interval change operation;

FIG. 9 illustrates signal transmission and reception between the moving image distribution server and the client terminal; and

FIG. 10 illustrates the case where incommunicable areas are intermittently present in a moving direction of the client terminal.

### EXPLANATION OF SYMBOLS

1 content distribution server; 2, 3 client terminal; 6 vehicle; 11 moving image storage unit; 12 moving image distribution unit; 13 moving image distribution control unit; 21 moving image reception unit; 22 reception buffer unit; 23 moving image decoding unit.

### BEST MODE FOR CARRYING OUT THE INVENTION

In a content distribution system and a method for controlling the same according to the present invention, when it is detected that an incommunicable area is present in a moving direction of a client terminal, the client terminal transmits a change request signal, requesting an increase of the confirmation interval of a keep-alive signal, to the content distribution server before the client terminal enters the incommunicable area. When the change request signal is received during distribution of content data, the content distribution server increases the confirmation interval of the keep-alive signal, thereby allowing the session of content distribution to be maintained while the client terminal is in motion within the incommunicable area. Accordingly, time measurement exceeding the keep-alive signal confirmation interval is prevented even when a keep-alive signal is not received by the content distribution server since the client terminal is in motion within an incommunicable area. As a result, the client terminal can maintain the session of distribution of content data without terminating the session until the client terminal exits the incommunicable area.

### EMBODIMENTS

The embodiments of the present invention will now be described in detail with reference to the accompanying drawings.

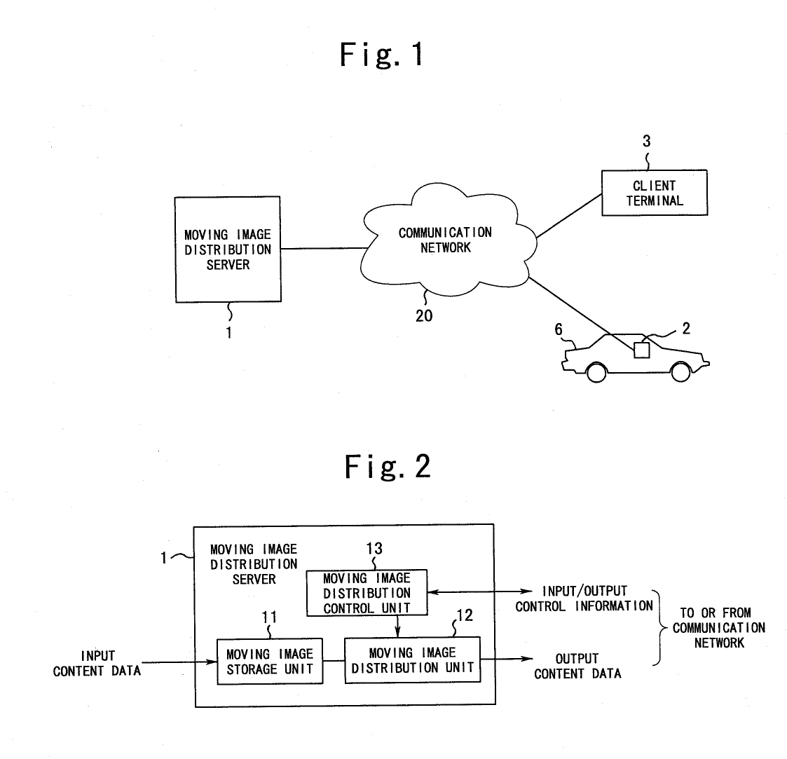

FIG. 1 illustrates a configuration of a content distribution system according to the present invention. The content distribution system is a system that distributes moving image content data and includes a content distribution server 1 and client terminals 2 and 3. The moving image distribution server 1 is fixedly installed and can always be connected to a communication network 20 such as the Internet. The client terminals 2 and 3 are movable. To clarify this, it is assumed in this embodiment that the client terminal 2 is mounted in a vehicle 6. The client terminal 3 may be portable and may also be in-vehicle, similar to the client terminal 2. It is also assumed that the client terminals 2 and 3 can be connected to the communication network 20 wirelessly through a wireless relay device (not shown) and cannot be connected to the communication network 20 when the client terminals 2 and 3 are in an incommunicable area such as a tunnel. The incommunicable area includes an unstable communication area.

As shown in FIG. 2, the moving image distribution server 1 includes a moving image storage unit 11, a moving image distribution unit 12, and a moving image distribution control unit 13. The moving image storage unit 11 stores a plurality of moving image content as moving image content data. The moving image storage unit 11 can also store moving image content data provided from an external database (not shown). An input side of the moving image distribution unit 12 is connected to the moving image storage unit 11 and an output side of the moving image distribution unit 12 is connected to the communication network 20. Under control of the moving image distribution control unit 13, the moving image distribution unit 12 reads moving image content data in units of transmission blocks from the moving image storage unit 11 and transmits the moving image content data to a transmission target. The moving image distribution control unit 13 transmits and receives control information to and from the client terminals 2 and 3 through the communication network 20 and also controls the content distribution operation of the moving image distribution unit 12. The control information includes a keep-alive signal, a signal requesting pause of distribution, a signal requesting change of a keep-alive confirmation interval T₀, and a signal requesting initialization of the confirmation interval T₀, which will be described later.

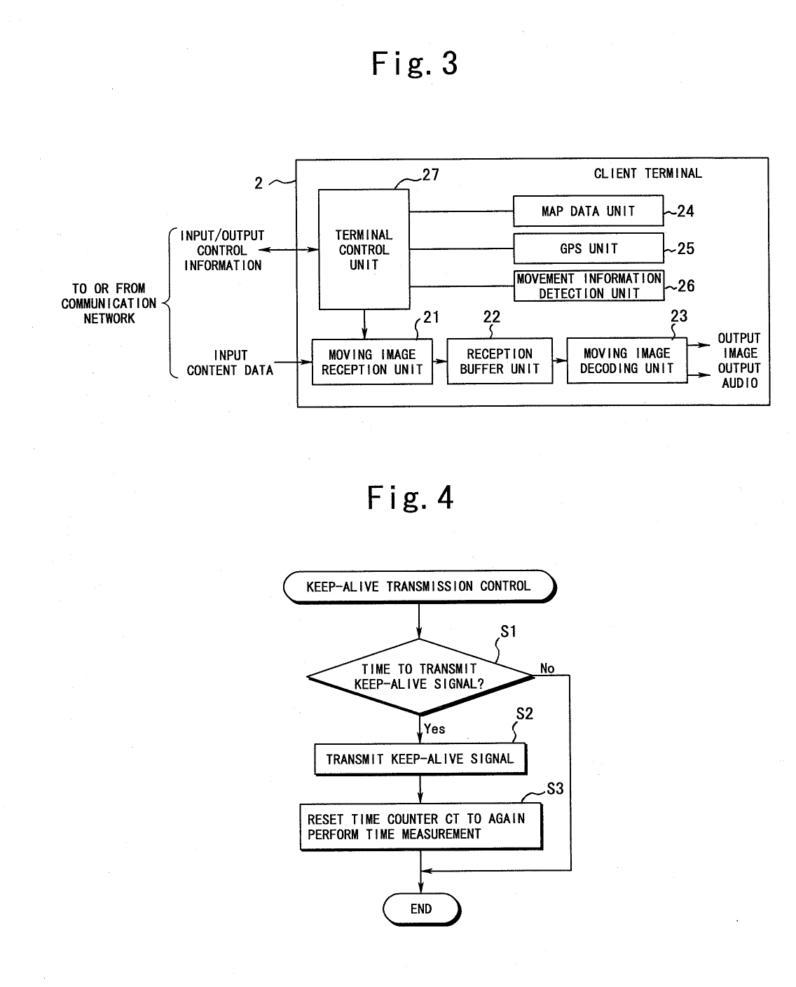

As shown in FIG. 3, the client terminal 2 includes a moving image reception unit 21, a reception buffer unit 22, a moving image decoding unit 23, a map data unit 24, a Global Positioning System (GPS) unit 25, a movement information detection unit 26, and a terminal control unit 27. An input side of the moving image reception unit 21 is connected to the communication network 20 and an output side of the moving image reception unit 21 is connected to the reception buffer unit 22. Under control of the terminal control unit 27, the moving image reception unit 21 receives moving image content data transmitted from the moving image distribution unit 12 of the moving image distribution server 1 and provides the received moving image content data to the reception buffer unit 22. The reception buffer unit 22 stores moving image content data received by the moving image reception unit 21. The moving image decoding unit 23 decodes the moving image content data stored in the reception buffer unit 22 and outputs an image signal and an audio signal. A display (not shown) on the client terminal 2 displays an image in accordance with the image signal and a speaker (not shown) of the client terminal 2 outputs a sound in accordance with the audio signal.

The map data unit 24 stores map data representing a road map in a range in which the vehicle 6 travels. The map data includes information representing the range of an incommunicable area on a road. The GPS unit 25 detects the current position of the vehicle 6, i.e., the current position of the client terminal 2. The movement information detection unit 26 detects at least the speed of the vehicle 6. The map data unit 24, the GPS unit 25, and the movement information detection unit 26 are connected to the terminal control unit 27.

The terminal control unit 27 includes, for example, a microcomputer, and controls the operation of the client terminal 2 to receive moving image content data distributed from the moving image distribution server 1.

The internal configuration of the client terminal 3 is similar to that of the client terminal 2. However, if the client terminal 3 is portable, the map data unit 24 and the movement information detection unit 26 are designed for portable terminals. That is, the map data unit 24 stores map data representing a road map in a range in which a user 6 moves and the movement information detection unit 26 detects the moving speed of the user.

Next, a description is given of the operation of the content distribution system when the moving image distribution server 1 distributes moving image content data to the moving image client terminal 2.

When the user of the client terminal 2 operates an operating unit (not shown) of the client terminal 2 to request distribution of moving image content data, the client terminal 2 transmits a connection request signal from the terminal control unit 27 to the moving image distribution control unit 13 of the moving image distribution server 1 through the communication network 20. Each of the moving image distribution control unit 13 and the terminal control unit 27 performs an operation for establishing a communication connection between the moving image distribution server 1 and the client terminal 2 in accordance with the connection request signal. Establishment of the communication connection includes authentication and is performed to specify the communication counterpart. If the user of the client terminal 2 performs an operation for designating desired moving image content data after the connection is established, then the designation information is transmitted to the moving image distribution control unit 13 of the moving image distribution server 1 through the communication network 20. When the moving image distribution control unit 13 receives the designation information, the moving image distribution unit 12 reads moving image content data corresponding to the designation information in units of transmission blocks from the moving image storage unit 11 and transmits the read moving image content data to the client terminal 2. The moving image content data is carried in packets and provided to the client terminal 2 through the communication network 20. For example, RTSP is used as a communication protocol for distribution of such content data.

When the moving image reception unit 21 of the client terminal 2 receives the moving image content data, the moving image content data is sequentially stored in the reception buffer unit 22. The moving image decoding unit 23 sequentially decodes the moving image content data stored in the reception buffer unit 22 and continuously outputs image and audio signals. The display of the client terminal 2 displays an image in accordance with the image signal and the speaker of the client terminal 2 outputs a sound in accordance with the audio signal.

When the client terminal 2 starts receiving content data, the terminal control unit 27 starts a keep-alive transmission control operation in order to maintain a connection of a moving image distribution session. As shown in FIG. 4, in the keep-alive transmission control operation, it is determined whether or not the time to transmit a keep-alive signal has been reached (step S1). Specifically, it is determined whether or not a time that has elapsed after a previous keep-alive signal was transmitted has approached the keep-alive confirmation interval T₀. The keep-alive signal confirmation interval T₀ is measured by a time counter CT (not shown) in the terminal control unit 27. When the elapsed time has reached a time which is close to the confirmation interval T₀ (for example, when the elapsed time has reached a time several seconds shorter than the confirmation interval T₀), a keep-alive signal is immediately transmitted to the moving image distribution server 1 (step S2). Through this keep-alive transmission operation, a keep-alive signal is transmitted to the moving image distribution server 1 at intervals of a period slightly shorter than the confirmation interval T₀. The time counter CT is reset to again measure the confirmation interval T₀ (step S3).

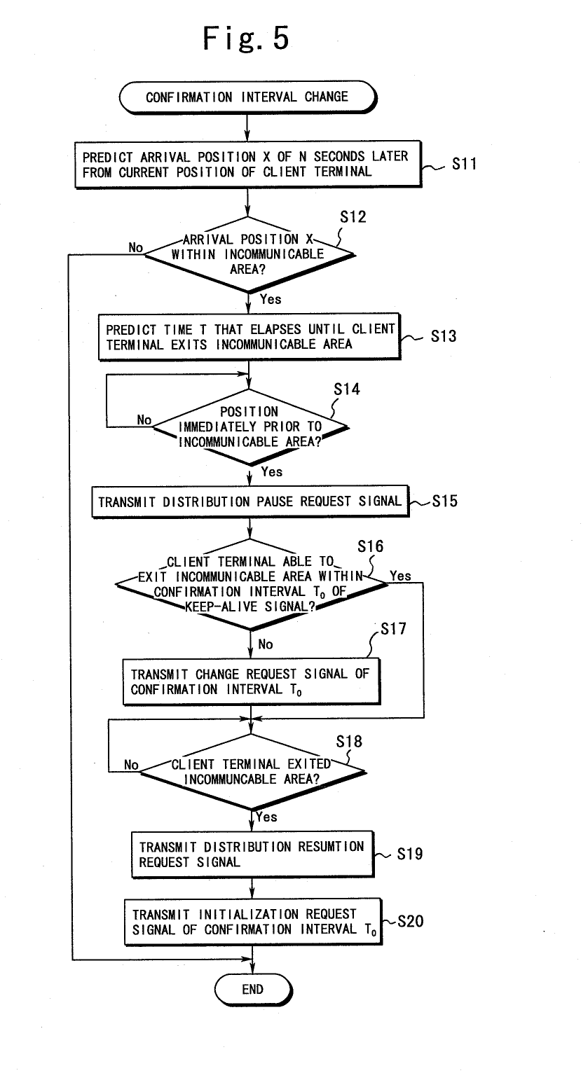

The terminal control unit 27 repeatedly performs an operation for changing the keep-alive confirmation interval T₀, separately from the keep-alive transmission control operation. As shown in FIG. 5, in the confirmation interval change operation, first, an arrival position X at which the client terminal 2 will arrive N seconds later is predicted from the current position of the client terminal 2 (step S11). The current position of the client terminal 2 is obtained from the GPS unit 25. The arrival position X of the client terminal 2 at N seconds later is predicted using both map data obtained from the map data unit 24 and a moving speed S obtained from the movement information detection unit 26. That is, a position, which is away from the current position on a road on which the client terminal 2 is currently in motion as indicated in the map data by a moving distance obtained through calculation of “N*S”, is detected from the map data as the predicted arrival position X.

Then, it is determined whether or not the arrival position X is included in the incommunicable area (step S12). The determination of step S12 is performed based on the map data obtained from the map data unit 24 since information indicating the range of the incommunicable area on the road is included in the map data as described above. A time T that elapses until the client terminal 2 exits the incommunicable area is predicted if the arrival position X is included in the incommunicable area (step S13). The time T that elapses until the client terminal 2 exits the incommunicable area specified at step S12 is predicted using the map data obtained from the map data unit 24 and the moving speed S obtained from the movement information detection unit 26. Specifically, the time T is calculated by dividing a distance to the end of the incommunicable area on the road on which the client terminal 2 is currently in motion as indicated in the map data by the moving speed S.

After step S13 is performed, it is determined whether or not the current position of the client terminal 2 is immediately prior to the incommunicable area specified at step S12 (step S14). The immediately prior position is, for example, a position 10 seconds before the client terminal 2 will enter the incommunicable area at the current moving speed S. If it is determined that the current position of the client terminal 2 is immediately prior to the incommunicable area, a signal requesting pause of distribution is transmitted to the moving image distribution server 1 (step S15). In addition, it is determined whether or not the client terminal 2 can exit the incommunicable area specified at step S12 within the current confirmation interval T₀ of the keep-alive signal (step S16). This determination is made based on the current measurement time of the time counter CT. That is, it is determined whether or not the client terminal 2 will exit the incommunicable area at the moving speed S within a remaining time of the confirmation interval T₀ which is obtained by subtracting the time measured by the time counter CT from the confirmation interval T₀. A signal requesting change of the confirmation interval T₀ is transmitted to the moving image distribution server 1 if it is determined that the client terminal 2 cannot exit the incommunicable area (step S17). If the initial value of the confirmation interval T₀ is “t0”, it is changed to a time of “t1”, which is longer than “t0” (i.e., t0<t1) such that the time counter CT does not terminate time measurement until the client terminal 2 exits the incommunicable area. On the other hand, the current confirmation interval T₀ is maintained at t0 if it is determined that the client terminal 2 cannot exit the incommunicable area.

After step S17 is performed, it is determined whether or not the client terminal 2 has exited the incommunicable area specified at step S12 (step S18). That is, it is determined whether or not the current position of the client terminal 2 obtained from the GPS unit 25 is outside the incommunicable area on the road on which the client terminal 2 is currently in motion. A signal requesting resumption of distribution is transmitted to the moving image distribution server 1 if the current position of the client terminal 2 is outside the incommunicable area (step S19). In addition, a signal requesting initialization of the confirmation interval T₀ is transmitted to the content distribution server (step S20). This step S20 may be omitted when it is determined at step S16 that the client terminal 2 can exit the incommunicable area within the current keep-alive confirmation interval T₀.

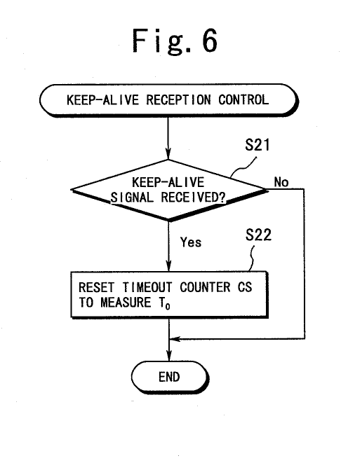

When the moving image distribution server 1 starts distribution of content data, the moving image distribution control unit 13 starts a keep-alive reception control operation in order to maintain the session of moving image distribution. In the keep-alive reception control operation, it is determined whether or not the keep-alive signal has been received as shown in FIG. 6 (step S21). A timeout counter CS (not shown) in the moving image distribution control unit 13 is reset to resume measurement of the confirmation interval T₀ if the keep-alive signal has been received (step S22).

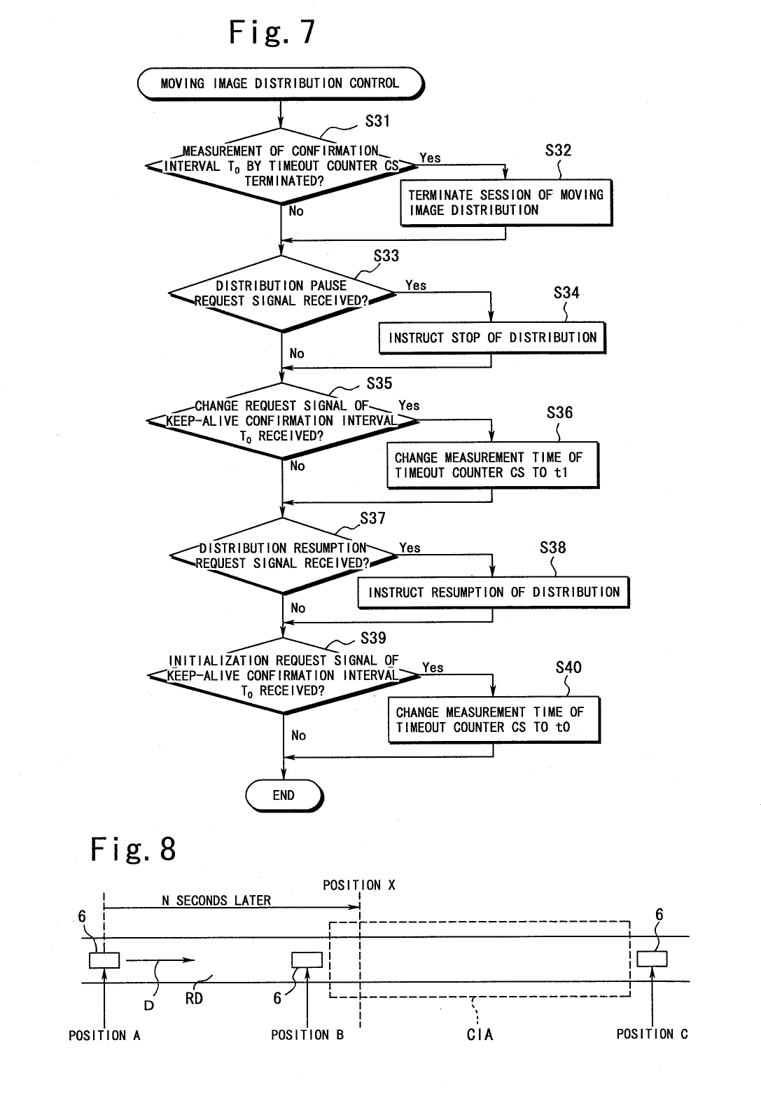

The moving image distribution control unit 13 repeatedly performs a moving image distribution control operation, separately from the keep-alive reception control operation. In the moving image distribution control operation, it is determined whether or not the timeout counter CS has terminated measurement of the confirmation interval T₀ as shown in FIG. 7 (step S31). If the measurement time of the timeout counter CS has exceeded the confirmation interval T₀, the moving image distribution session is terminated (step S32). That is, the communication connection between the moving image distribution server 1 and the client terminal 2 is released and distribution of moving image content data to the client terminal 2 through the moving image distribution unit 12 is stopped.

On the other hand, if the measurement time of the timeout counter CS has not exceeded the confirmation interval T₀, it is determined whether or not a signal requesting pause of distribution has been received (step S33). If the distribution pause request signal has been received, the moving image distribution control unit 13 instructs the moving image distribution unit 12 to temporarily stop distribution of moving image content data to the client terminal 2 (step S34). The moving image distribution unit 12 stops transmission of moving image content data to the client terminal 2 and also stops reading of moving image content data from the moving image storage unit 11. If no signal requesting pause of distribution has been received, this control operation proceeds to step S35, bypassing step S34.

After step S34 is performed, it is determined whether or not a signal requesting change of the confirmation interval T₀ has been received (step S35). When the change request signal has been received by the moving image distribution control unit 13, the measurement time of the timeout counter CS is changed to a time of “t1” (step S36). When no change request signal has been received, this control operation proceeds to step S37, bypassing step S36.

After step S36 is performed, it is determined whether or not a signal requesting resumption of distribution has been received (step S37). When the distribution resumption request signal has been received by the moving image distribution control unit 13, the moving image distribution control unit 13 instructs the moving image distribution unit 12 to resume distribution of moving image content data to the client terminal 2 (step S38). In accordance with the distribution resumption instruction, the moving image distribution unit 12 resumes transmission of moving image content data to the client terminal 2 and also resumes reading of moving image content data from the moving image storage unit 11. When no distribution resumption request signal has been received, this control operation proceeds to step S39, bypassing step S38.

Then, it is determined whether or not a signal requesting initialization of the confirmation interval T₀ has been received (step S39). When the initialization request signal has been received by the moving image distribution control unit 13, the measurement time of the timeout counter CS is changed to a time of “t0” (step S40).

Although, actually, the moving image distribution control unit 13 transmits a response signal to each of the distribution pause request signal, the change request signal of the confirmation interval T₀, the distribution resumption request signal, and the initialization request signal of the confirmation interval T₀ to the client terminal 2 upon receiving each request signal, a description of the transmission of the response signal is omitted in the above description.

Let us assume that, while moving image content data is being distributed through the operations of the moving image distribution server 1 and the client terminal 2 as described above, a vehicle 6 in which the client terminal 2 is mounted is traveling on a road RD in a direction of an arrow D as shown in FIG. 8. Let us also assume that a tunnel is present on the road RD in the travel direction and the tunnel part of the road RD is an incommunicable area CIA.

If step S12 is performed when the client terminal 2 is at a position A on the road RD, an arrival position X at which the client terminal 2 will arrive N seconds later from the current position is determined to be included in the incommunicable area CIA.

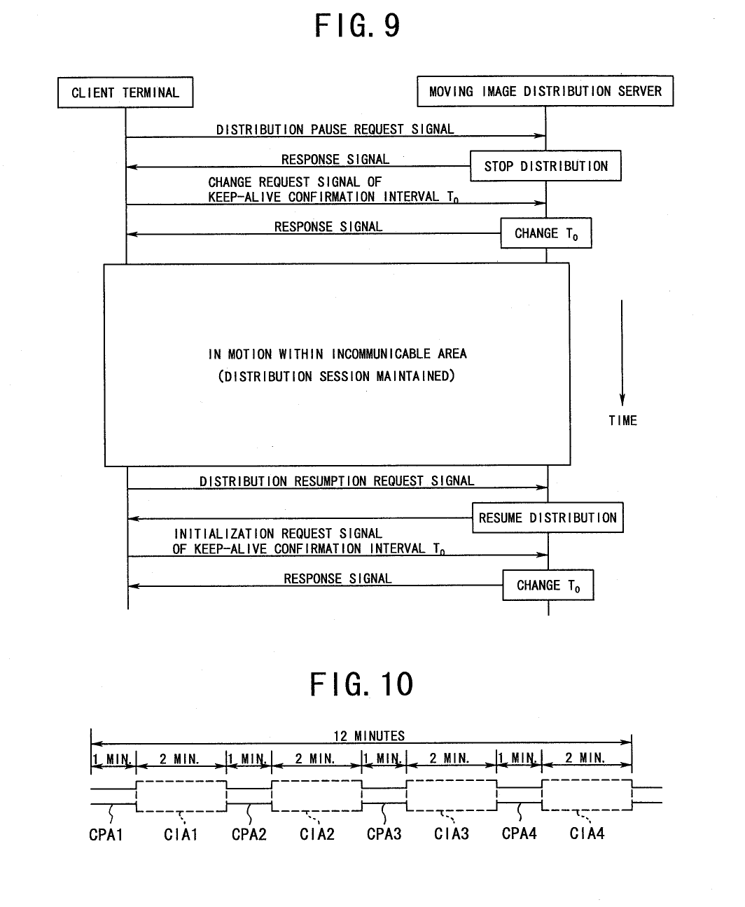

If it is determined at step S14 that the current position of the client terminal 2 is immediately prior to the incommunicable area CIA when the vehicle 6 has reached a position B on the road RD, then step S15 is performed to transmit a distribution pause request signal from the client terminal 2 to the moving image distribution server 1 as shown in FIG. 9. When the distribution pause request signal has been received by the moving image distribution control unit 13, the moving image distribution unit 12 temporarily stops distribution and a response signal is transmitted from the moving image distribution server 1 to the client terminal 2. In the client terminal 2, after the distribution pause request signal is transmitted, step S16 is performed to determine whether or not the client terminal 2 can exit the incommunicable area CIA within the current keep-alive confirmation interval T₀. When it is determined that the client terminal 2 cannot exit the incommunicable area CIA, step S17 is performed to transmit a change request signal of the keep-alive confirmation interval T₀ from the client terminal 2 to the moving image distribution server 1. When the change request signal has been received by the moving image distribution control unit 13, the moving image distribution control unit 13 performs step S36 to change the measurement time of the timeout counter CS to a time of t1. In response to reception of the change request signal, the moving image distribution server 1 transmits a response signal to the client terminal 2.

Since the measurement time of the timeout counter CS has been changed to the time t1, the timeout counter CS does not terminate time measurement so that the moving image distribution session is maintained in the moving image distribution server 1 while the vehicle 6 is traveling within the incommunicable area CIA.

When the vehicle 6 has exited the incommunicable area CIA, reaching a position C on the road RD, step S19 is immediately performed to transmit a distribution resumption request signal from the client terminal 2 to the moving image distribution server 1. When the distribution resumption request signal has been received by the moving image distribution control unit 13, the moving image distribution unit 12 resumes distribution and a response signal is transmitted from the moving image distribution server 1 to the client terminal 2.

In the client terminal 2, after the distribution resumption request signal is transmitted, step S20 is performed to transmit an initialization request signal of the keep-alive confirmation interval T₀ from the client terminal 2 to the moving image distribution server 1. When the initialization request signal has been received by the moving image distribution control unit 13, step S40 is performed to return measurement time of the timeout counter CS to the original time t0. In addition, a response signal to the reception of the change request signal is transmitted from the moving image distribution server 1 to the client terminal 2.

In the content distribution system described above, when the client terminal 2 moves to an incommunicable area, the preset time of the keep-alive confirmation interval T₀ is changed immediately before the client terminal 2 enters the incommunicable area such that the timeout counter CS of the moving image distribution server 1 does not terminate time measurement of the keep-alive confirmation interval T₀. As a result, it is possible to prevent termination of the session until the client terminal 2 exits the incommunicable area. Thus, when the client terminal 2 exits the incommunicable area, distribution is immediately resumed so that the client terminal 2 can receive moving image content data. That is, when the client terminal 2 exits the incommunicable area, the client terminal 2 can receive moving image content data distributed by the moving image distribution server 1 without reestablishing a communication connection with the moving image distribution server 1.

In the above embodiment, taking into consideration that step S31 is performed immediately after the measurement time of the timeout counter CS returns to the original time “t0”, step S2 may, before the client terminal 2 transmits the initialization request signal of the keep-alive confirmation interval T₀, be forcibly performed to transmit a keep-alive signal to the moving image distribution server 1 so that the measurement time of the timeout counter CS is reset.

In addition, immediately before the client terminal 2 enters an incommunicable area, step S2 may be forcibly performed to transmit a keep-alive signal to the moving image distribution server 1 so that the measurement time of the timeout counter CS is reset. In this case, the changed time “t1” of the keep-alive confirmation interval T₀ may be about a predicted time that elapses until the client terminal 2 exits the incommunicable area.

Although a distribution pause request signal is transmitted immediately before the client terminal 2 enters the incommunicable area in the above embodiment, the distribution pause request signal may not necessarily be transmitted. In this case, of course, the client terminal 2 cannot receive moving image content data while it is in motion in the incommunicable area. However, when the client terminal 2 exits the incommunicable area, it can immediately receive moving image content data without transmitting a distribution resumption request signal.

In addition, before the client terminal 2 enters an incommunicable area after detecting that the arrival position X of the client terminal 2 at N seconds later is included in the incommunicable area, the client terminal 2 may request that the moving image distribution server 1 increase or change the transfer rate or coding rate of content data so that the amount of content data stored in the reception buffer unit 22 of the client terminal 2 is maximized immediately before the client terminal 2 enters the incommunicable area as described in Japanese Patent Application Publication No. 2006-173973. This allows the client terminal 2 to continuously reproduce and output content even when it is in motion in the incommunicable area.

Although map data is used to detect presence of the incommunicable area in the above embodiment, any other detection method may be used, provided that the client terminal 2 can obtain information indicating presence of the incommunicable area while it is in motion or that the client terminal 2 can internally determine presence of the incommunicable area based on reception conditions.

In addition, in the content distribution system according to the present invention, when incommunicable areas are intermittently present in the moving direction of the client terminal, for example, when the client terminal is in a range in which communicable areas CPA1 to CPA4 and incommunicable areas CIA1 to CIA4 are alternately present as shown in FIG. 10, a change request signal of the keep-alive confirmation interval T₀ may be transmitted, treating the incommunicable areas CIA1 to CIA4 as one incommunicable area. A number of each area in FIG. 10 indicates a predicted time length for passing through the area and at least 12 minutes are assigned to a change request signal of the keep-alive confirmation interval T₀ transmitted immediately before the client terminal enters the incommunicable area CIA1. Accordingly, it is possible to reduce the amount of communication for distribution control between the moving image distribution server and the client terminal.

The present invention is not limited to an in-vehicle terminal as in the above embodiment and may also be applied to the case where the client terminal is in motion while being carried by a user.

The present invention may also be applied to a navigation system having a distribution function. Not only a terminal for use only with data distribution but also a mobile phone including a PHS (personal handy-phone system), a PDA (personal digital assistant), or a notebook PC may be used as the client terminal.

1. A content distribution system comprising a content distribution server which performs distribution of content data and a movable client terminal which receives the content data distributed from the content distribution server after establishing a communication connection with the content distribution server,
the client terminal including:
a first transmission unit which repeatedly transmits a keep-alive signal, indicating that the communication connection is effective during distribution of the content data, to the content distribution server;
a detection unit which detects presence of an incommunicable area in a moving direction of the client terminal; and
a second transmission unit which transmits a change request signal, requesting an increase of a confirmation interval of the keep-alive signal, to the content distribution server before the client terminal enters the incommunicable area,
the content distribution server including:
a reception unit which receives a signal transmitted from the client terminal, the signal including the keep-alive signal and the change request signal, during distribution of the content data;
a distribution control unit which terminates a session of the content data distribution when a next keep-alive signal is not received within the confirmation interval from a time at which a previous keep-alive signal is received; and
a setting unit which increases the confirmation interval when the change request signal is received, thereby allowing the session to be maintained while the client terminal is in motion within the incommunicable area.

2. The content distribution system according to claim 1, wherein the client terminal further includes a third transmission unit which transmits an initialization request signal requesting initialization of the confirmation interval of the keep-alive signal when the client terminal exits the incommunicable area,
wherein the setting unit returns the confirmation interval to an initial value when the initialization request signal is received by the reception unit.

3. The content distribution system according to claim 1, wherein the client terminal further includes:
a fourth transmission unit which transmits a distribution pause request signal to the content distribution server before the client terminal enters the incommunicable area; and
a fifth transmission unit which transmits a distribution resumption request signal to the content distribution server when the client terminal exits the incommunicable area,
wherein the content distribution server includes a unit which stops distribution of the content data to the client terminal when the distribution pause request signal is received by the reception unit and releases the stopped state of the distribution of the content data and resumes distribution of the content data to the client terminal when the distribution resumption request signal is received by the reception unit.

4. The content distribution system according to claim 1, wherein the detection unit detects presence of an incommunicable area in a moving direction of the client terminal using map data in which a plurality of incommunicable areas are indicated previously.

5. The content distribution system according to claim 1, wherein the second transmission unit includes a time prediction unit which predicts a time required to move through the incommunicable area detected by the detection unit and transmits the change request signal specifying a time of the confirmation interval corresponding to the predicted time, and
wherein the setting unit sets the confirmation interval to the time specified by the change request signal.

6. The content distribution system according to claim 5, wherein, when it is detected by the detection unit that a plurality of incommunicable areas are intermittently present in a moving direction of the client terminal, the time prediction unit treats the plurality of incommunicable areas as a single incommunicable area and predicts a time required to move through the single incommunicable area.

7. A method for controlling a content distribution system including a content distribution server which performs distribution of content data and a movable client terminal which receives content data distributed from the content distribution server after establishing a communication connection with the content distribution server, comprising the steps of:
in the movable client terminal,
repeatedly transmitting a keep-alive signal, indicating that the communication connection is effective during distribution of the content data, to the content distribution server;
detecting presence of an incommunicable area in a moving direction of the client terminal; and
transmitting a change request signal, requesting an increase of a confirmation interval of the keep-alive signal, to the content distribution server before the client terminal enters the incommunicable area, and further comprising the steps of:
in the content distribution server,
receiving a signal transmitted from the client terminal, the signal including the keep-alive signal and the change request signal, during distribution of the content data;
terminating a session of distribution of the content data when a next keep-alive signal is not received within the confirmation interval from a time at which a previous keep-alive signal is received; and
increasing the confirmation interval when the change request signal is received, thereby allowing the session to be maintained while the client terminal is in motion within the incommunicable area.
